(19) United States
(12) Patent Application Publication
(10) Pub. No.: US 2013/0220379 A1
(43) Pub. Date: Aug. 29, 2013

(54) METHOD AND DEVICE FOR CLEANING COKED CAVITIES, IN PARTICULAR INLET CHANNELS AND VALVES OF AN INTERNAL COMBUSTION ENGINE

(71) Applicants: Friedrich A. Sprügel, Muenchen (DE); Alfons Urban, Bad Heilbrunn (DE)

(72) Inventors: Friedrich A. Sprügel, Muenchen (DE); Alfons Urban, Bad Heilbrunn (DE)

(73) Assignee: TUNAP INDUSTRIE CHEMIE GmbH & Co. PRODUKTIONS KG, Wolfratshausen (DE)

(21) Appl. No.: 13/818,585

(22) PCT Filed: Aug. 24, 2011
(86) PCT No.: PCT/EP2011/004251

§ 371 Date: Mar. 18, 2013

(30) Foreign Application Priority Data
Aug. 24, 2010 (DE) 10 2010 039 696.6

(51) Int. Cl. B08B 3/08

(52) U.S. Cl. CPC B08B 3/08
USPC 134/21; 134/105

(57) ABSTRACT

The invention relates to a method for cleaning coked cavities, in particular inlet, channels (10) and valves (15) of an internal combustion engine (12), comprising the following steps: introducing an alkaline liquid into a cavity to be cleaned; heating the alkaline liquid; and extracting the alkaline liquid and the dirt particles contained therein by suction from the cavity. Said method can be carried out especially simply and effectively using a device comprising a first probe (21), which is provided at the leading end thereof with one or more nozzles (23) for injecting an alkaline liquid into the cavity to be cleaned and which is connected at the other end thereof to the delivery side (24) of a pump (25), wherein warmed alkaline liquid can be supplied to the intake side (26) of said pump. A second probe (22) is provided for extracting the alkaline fluid and the dirt particles contained therein by suction from the cavity.

The present invention relates to a method and a device for cleaning coked cavities, in particular inlet channels and valves of an internal combustion engine.

In internal combustion engines, such as gasoline and diesel engines, contaminants frequently occur in the inlet channels and on the inlet valves, which contaminants are caused, in particular, by fuels of lower quality and/or unfavorable operation of the engines. The contaminants are mainly hard and soft and greasy carbon deposits which disrupt the engine operation more and more as they grow, since the required inlet cross sections are no longer achieved when the inlet valves are opened.

If nothing is undertaken against deposits of this type, massive disruptions can occur at the inlet valves, the consequence of which is that the entire cylinder head of an engine has to be replaced.

The invention is based on the object of providing a method and a device for cleaning coked cavities, in particular inlet channels of an internal combustion engine, which method or device makes effective elimination of contaminants and deposits possible with simple handling, even at points which are difficult to access.

This object is achieved by the method as claimed in patent claim 1 and the device as claimed in patent claim 8. Advantageous developments and refinements of the invention are described in the respective subclaims.

It is therefore provided according to the invention that the method for cleaning cavities, in particular inlet channels, comprises the following steps: introduction of an alkaline liquid into a cavity to be cleaned, heating of the alkaline liquid, and extraction by suction of the alkaline liquid with the dirt particles contained therein from the cavity, the alkaline liquid having, in particular, a pH value of from 7 to 14.

In a first refinement of the invention, it is provided that a base in solid form and a solvent are mixed with one another and are introduced into the cavity to be cleaned, with the result that the alkaline liquid is formed in the cavity to be cleaned by dissolving of the base in the solvent with the development of heat. Here, the cleaning action of the alkaline liquid is increased considerably by the exothermic reaction, since the heat which is produced can be used practically completely to heat the alkaline liquid and the contaminants to be removed. The suspended dirt particles are extracted by suction with the aid of a pump.

In another refinement of the invention, it is provided that the alkaline liquid is heated before being introduced, and the heated alkaline liquid is injected into the cavity, the liquid with the dirt particles contained therein being extracted by suction from the cavity, while alkaline liquid continues to be injected into the cavity, with the result that the cavity is flushed continuously with alkaline liquid.

In order to build up a continuous flushing circuit, it is advantageous if the alkaline liquid with the dirt particles contained therein is extracted by suction from the cavity and is subsequently filtered, in order to remove the dirt particles contained therein, and the filtered alkaline liquid is heated and is subsequently injected into the cavity again. As a result, the consumption of cleaning liquid can be kept low, without the effectiveness of the cleaning method being impaired.

In order to assist the chemical cleaning effect mechanically, it is provided that the alkaline liquid is sprayed under pressure against the walls and the bottom of the cavity.

Furthermore, it is expedient, after the extraction by suction of the alkaline liquid has ended, to dry the cavity by means of compressed air.

Furthermore, it is provided according to the invention that the device for cleaning coked cavities, in particular inlet channels, comprises the following: a first probe which is provided at its front end with one or more nozzles for injecting a heated alkaline liquid into a cavity to be cleaned and which is connected with its other end to the pressure side of a pump, the suction side of which can be fed heated alkaline liquid; and a second probe for extracting the alkaline liquid with the dirt particles contained therein by suction from the cavity. By way of the device according to the invention, the alkaline liquid can be introduced effectively even into regions of cavities which are difficult to access, where said alkaline liquid can then develop its cleaning action completely.

In order to build up a continuous flushing circuit here, it is advantageous if the second probe is connected to the suction side of the pump via a filter for removing dirt particles from the alkaline liquid. Together with the pump and the filter, the two probes therefore form an open system which is closed via the cavity to be cleaned to form a circuit for the alkaline liquid.

The outlet side of the filter is expediently connected via a connecting line, which is assigned a heater for heating a liquid which flows through, to the suction side of the pump. Heating of the alkaline liquid in the pressure side is also possible.

In one advantageous refinement of the device according to the invention, it is provided that the first probe is a thin tube which is closed at its front end and in the circumferential wall of which a plurality of radially directed nozzles are provided. Here, the nozzles can be arranged on a line which is parallel to the axis of the tube.

However, it is also possible that the first probe has at least two nozzles for injecting the alkaline liquid into the cavity to be cleaned, which nozzles spray the alkaline liquid in different directions. Here, the nozzles can be arranged on one or more helixes or on one or more circumferential circles.

Furthermore, it is expedient if at least one nozzle is provided in the region of the closed front end, through which at least one nozzle the alkaline liquid can be sprayed substantially in the axial direction of the tube of the probe.

In the following text, the invention will be explained in greater detail using the drawing, in which:

FIG. 1 shows a simplified diagrammatic sectional illustration of an inlet channel of an internal combustion engine, for example a diesel engine,

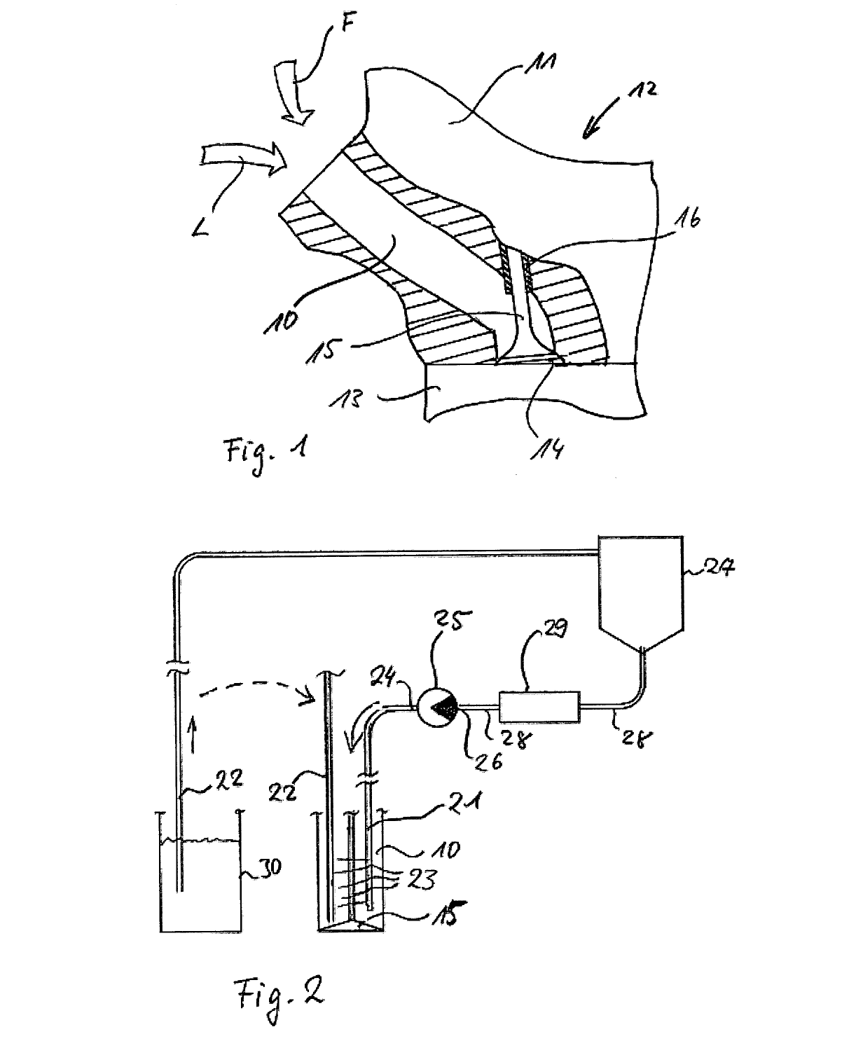

FIG. 2 shows a simplified diagrammatic block illustration of a device according to the invention for cleaning cavities, in particular for cleaning inlet channels and valves in internal combustion engines,

FIG. 3 shows simplified diagrammatic illustrations of different embodiments of a first probe for injecting an alkaline liquid into a cavity to be cleaned,

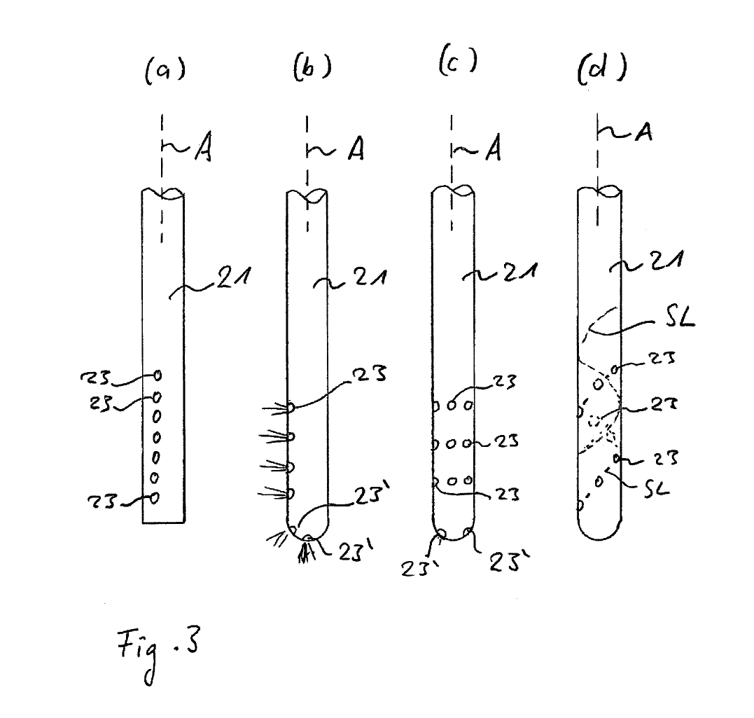

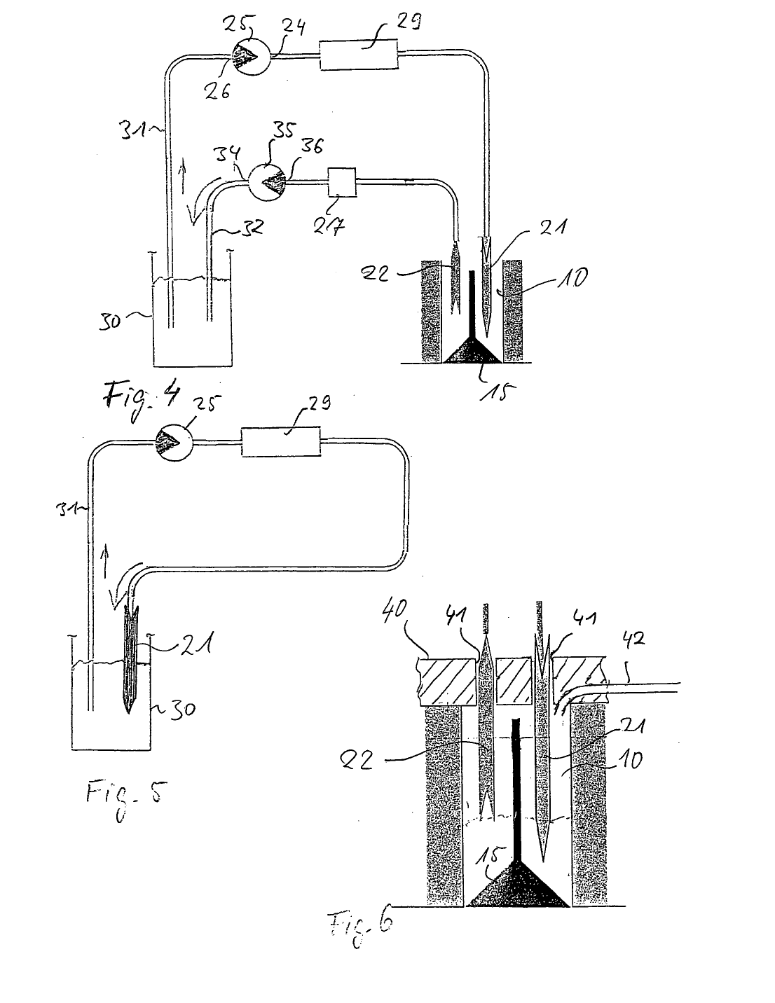

FIG. 4 shows a simplified diagrammatic block illustration of a device according to the invention according to one advantageous development,

FIG. 5 shows a simplified diagrammatic block illustration of the device according to the invention in accordance with FIG. 4, with a circuit which is short-circuited for preheating, and

FIG. 6 shows a simplified diagrammatic illustration of a covering device for the opening of a cavity to be cleaned.

In the various figures of the drawing, mutually corresponding components are provided with the same reference signs.

FIG. 1 is one example for a cavity to be cleaned, namely an inlet channel 10 in a cylinder head 11 of an internal combustion engine, for example a diesel engine 12, which cylinder head 11 is mounted in a customary way on a corresponding cylinder block 13. An outlet opening 14; opening into a cylinder (not shown in greater detail) in the cylinder block 13, of the inlet channel 10 is closed in a conventional way by an inlet valve 15 which is guided by means of a corresponding valve guide 16 in the cylinder head 11, in order to open and close the opening 14 of the inlet channel in accordance with the engine controller.

The inlet channels 10 and the inlet valves 15 of diesel engines become coked to a very pronounced extent. Here, what are known as swirl channels (not shown in greater detail) are particularly affected, which swirl channels are used in modern diesel engines with in each case four valves per cylinder, in order to impart a swirl to the gas mixture which is to be fed to the cylinder, which swirl is intended to lead to improved mixing of air and injected fuel. The deposits in the inlet channels 10 and on the inlet valves 15 are, in particular, soft, greasy carbon deposits.

According to a first exemplary embodiment of the present invention, the inlet channels 10 and the inlet valves 15 are cleaned by an alkaline liquid being introduced into the inlet channel 10 after the inlet-side openings 17 of the inlet channels 10 in the cylinder head 11 are opened, which alkaline liquid has either been heated beforehand or is heated substantially after being introduced. It is particularly expedient here if the heat of solution from the solution of a base in a corresponding solvent is utilized to heat the alkaline liquid.

It is particularly advantageous here if the base, for example potassium base or sodium base, is filled into the inlet channel 10 in solid form, as indicated by the arrow L in FIG. 1, in order to feed in a solvent subsequently or partly also at the same time, as indicated by the arrow F, with the result that the dissolving of the base in the solvent takes place in the inlet channel 10, with the result that the cleaning action of the base is assisted in an optimum manner by the heat which is developed during the dissolving. Every suitable solvent, such as water or alcohol, can be used here as solvent. However, particularly satisfactory cleaning results are achieved if hydrogen peroxide is used as solvent. Here, the mixing ratio of base (in solid form) and solvent is selected in such a way that the resulting alkaline liquid has a pH value of from 7 to 14, in particular of more than 12.

After a sufficient action time, during which the hard and/or soft, greasy carbon deposits are dissolved in the alkaline liquid and are therefore removed from the walls of the inlet channel 10 and the injection valve 15, the alkaline liquid together with the dirt particles contained therein is extracted by suction from the inlet channel 10 by means of an extraction probe (not shown in greater detail).

Subsequently, flushing of the inlet channel 10 with water or alcohol can then also take place, in order finally, after the cleaning of the inlet channels 10 and the inlet valves 15, to dry them with compressed air before the diesel engine is reassembled.

The exemplary embodiment which is described can be modified slightly by virtue of the fact that the mixing of base in solid form and solvent does not take place as late as in the inlet channel 10, but rather beforehand, the filling of the base/solvent mixture into the inlet channel 10 immediately following the mixing, with the result that the base does not dissolve in the solvent until the mixture of base and solvent is already situated in the inlet channel 10.

As shown in FIG. 2, a device according to the invention for cleaning cavities, in particular inlet channels, 10 of an internal combustion engine, for example a diesel engine 12, comprises a first probe 21 and a second probe 22. The first probe 21 is provided at its front end with one or more nozzles 23 for injecting an alkaline liquid into a cavity to be cleaned and are connected with their other end to the pressure side 24 of a pump 25, the suction side 26 of which can be fed heated alkaline liquid from a filter 27 via a connecting line 28 which is assigned a heater 29. The second probe 22 is connected to an inlet side of the filter 27, with the result that it is connected to the suction side 26 of the pump 25 via the filter 27 which serves to remove dirt particles from the alkaline liquid and via the connecting line 28. Here, the liquid which is sucked in by the pump 25 from the filter 27 via the connecting line 28 is heated to a desired temperature by the heater 29 which is assigned to the connecting line 28. The heater can also be arranged on the pressure side of the pump 25 in a way which is not shown in greater detail.

In order to assist the chemical cleaning action of the alkaline liquid mechanically, the first probe 21 is configured as a thin tube which is closed at its front end and in the circumferential wall of which a plurality of radially directed nozzles 23 are provided, as is shown, in particular, in FIG. 3. Here, the number and the diameter of the nozzles 23 is designed, with consideration of the pressure which can be generated by the pump 25, in such a way that the individual jets which exit the nozzles 23 are so powerful that they can bring about mechanical detaching of the carbon deposits which are to be removed.

As is shown in FIG. 3(b), in addition to the nozzles 23 which are arranged on a line which is parallel to the axis A of the tube, one or more additional nozzles 23′ can be provided, through which the alkaline liquid, as is indicated in the drawing, can be sprayed in the axial direction or at least with a substantial proportion in the axial direction.

According to another embodiment, the nozzles 23 can also be arranged on one or more helixes (SL in FIG. 3(d)) or on one or more circumferential circles (FIG. 3(c)). Here, the individual nozzles 23 can be distributed circumferentially in a uniform or non-uniform manner.

In order to clean an inlet channel 10 and an inlet valve 15 of a diesel engine with the aid of the device which is described, first of all the second probe 22 which is provided for extracting the alkaline liquid from the inlet channel 10 by suction is dipped into a storage vessel 30 with alkaline cleaning liquid, whereupon the pump 25 is switched on, which pump 25, as a result, sucks liquid from the storage vessel 30 by way of the second probe 22, first of all into the filter 27 and, furthermore, via the connecting line 28, and finally, after the air has been removed from the system, sprays alkaline liquid through the nozzles 23 in the first probe 21 into the inlet channel 10. As soon as the system comprising second probe 22, filter 27, connecting line 28, pump 25 and first probe 21 is filled with alkaline liquid and a suitable quantity of alkaline liquid has accumulated in the inlet channel 10, the second probe 22 is removed from the storage vessel 30 and is likewise inserted into the inlet channel 10, in order then to remove therefrom the alkaline liquid which is situated therein together with the dirt particles contained therein, that is to say mechanically and/or chemically detached dirt particles. The cleaning liquid is then cleaned in the filter 27 and, when fed through the connecting line 28, is heated to the desired temperature again by the heater 29 and is then sprayed or injected again under pressure into the inlet channel 10 by means of the pump 25, the individual liquid jets striking the walls of the inlet channel 10 itself and the surface of the inlet valve 15.

As in the first exemplary embodiment, it has to be ensured here that the inlet valves 15 of the inlet channels 10 to be cleaned are closed reliably. After the inlet channel 10 is then filled, as described above, with a corresponding quantity of alkaline cleaning liquid and the second probe 22 is moved from the storage vessel 30 into the inlet, channel 10, a flushing circuit is built up, in which the cleaning agent (alkaline cleaning liquid) which is continuously extracted by suction is fed continuously to the inlet channel 10 again after treatment in the filter 27 and renewed heating by the heater 29. The continuous supply of the alkaline cleaning liquid under pressure by means of the first probe 21 provides the additional mechanical washing action, as has already been mentioned above.

Here, as in the first exemplary embodiment, the cleaning can also be ended by flushing with water or alcohol and subsequent drying with compressed air.

Tests on diesel engines have shown that, in the case of relatively short inlet channels which are only slightly curved and in which the contaminants are considerably lower compared with what are known as the swirl channels, very satisfactory cleaning actions can already be achieved by way of a straight probe. In the case of what are known as swirl channels, that is to say in the case of relatively long, curved inlet channels with a lateral inlet opening for swirl generation, there are usually heavy contaminants, above all in the region of the inlet valve. Here, a probe has proven expedient which sprays in a plurality of directions, in particular in a plurality of radial and axial directions, with the result that all points of the channel walls and of the inlet valve can be reached.

The invention therefore provides a simple and reliable cleaning method for cleaning cavities, in particular coked cavities such as the inlet channels of an internal combustion engine, for example of a diesel engine, by way of which the service life of the latter can be extended considerably in an inexpensive way with timely use.

The device according to the invention (shown in FIG. 4) for cleaning cavities, in particular inlet channels 10 of an internal combustion engine, for example of a diesel engine 12, comprises, like the device which was explained above using FIG. 2, a first probe 21 and a second probe 22. The first probe 21 which has one or more nozzles 23 at its front end, as has already been described above, is connected with its other end via a heater 29 to the pressure side 24 of a first pump 25, the suction side 26 of which is connected via a corresponding intake line 31 to a storage vessel 30. The second probe 22, that is to say the suction probe, is connected via a filter 27 to the suction side 36 of a second pump 35, the pressure side 34 of which is connected via a return line 32 to the storage vessel 30.

Instead of a single pump, the cleaning device which is shown using FIG. 4 therefore has two pumps, namely the first pump 25 which serves as pressure pump for injecting the alkaline liquid into the cavity to be cleaned and the second pump 35 which serves as suction pump for extracting alkaline liquid and contaminants by suction from the cavity. The outlet or the pressure side 34 of the second pump 35 delivers the liquid, which is extracted by suction from the cavity and is filtered, via the return line 32 back into the storage vessel 30, from which alkaline liquid is then fed via the intake line 31 to the inlet or suction side 26 of the first pump. The liquid circuit is therefore open in the region of the cavity to be cleaned and in the region of the storage vessel 30.

In order to prevent splashing of the alkaline liquid for reasons of operational safety, the intake line 31 and the return line 32 are introduced in a sealed manner into the storage vessel 30 via a corresponding adapter cover (not shown in greater detail) which can be screwed onto the inlet and outlet stubs of said storage vessel 30.

In order for it to be possible to cover the inlet opening of the cavity to be cleaned, in particular of the inlet channel 10 to be cleaned, in order to prevent splashing of the liquid, which is injected under pressure into the cavity, into the surroundings, a covering device is provided which is configured as an adapter plate 40 and can be screwed on in a way which is not shown in greater detail, for example by means of screws on the cylinder head 11.

The adapter plate 40 has two openings 41, through which the two probes 21, 22 can be guided in a substantially sealed manner. Here, the through openings 41 can either be provided with seals which are resistant to the alkaline liquid and are made from synthetic or natural rubber or the like. However, it is also possible, to produce the adapter plate 40 from a sealing material of this type and to fasten it to the cylinder head 11 with the aid of a metallic fastening frame.

Since it can occur, in particular in the region of the cavity to be cleaned, that more cleaning liquid is fed in than is extracted by suction, an overflow 42 is expediently provided, the outlet side of which can be connected to a collecting vessel (not shown).

However, the adapter plate 40 which is shown in figure only for covering the opening of a single inlet channel 10 can also be configured in such a way that all the valve inlet channels which lie in one line or in one plane can be covered by way of it, with the result that the mounting complexity can be reduced considerably during the cleaning of the inlet channels in the workshop.

Before the actual cleaning of an inlet channel 10 and an inlet valve 15 of an internal combustion engine with the aid of the device which is shown using FIG. 4, first of all the liquid circuit is short-circuited by virtue of the fact that the first probe 21, that is to say the probe for injecting liquid into the cavity, is introduced instead of the return line 32 into the storage vessel 30. Alkaline liquid which is extracted from the storage vessel 30 by suction is then heated via the heater 29 which is arranged downstream of the first pump 25 here, and is conveyed back into the storage vessel 30. This operation can be repeated until the alkaline cleaning liquid in the storage vessel 30 has reached a desired temperature.

This operation is also possible with the cleaning device which is described using FIG. 2.

Subsequently, after the switching off of the pump 25, the first probe 21, that is to say the pressure probe for injecting the alkaline cleaning liquid into the cavity to be cleaned, is introduced into said cavity, this advantageously taking place by way of the adapter plate 40, as is shown in FIG. 6. Thereupon, the circuit via the second probe 22 which serves as suction probe, the filter 27, the pump 35 and the return line 32 is closed. Here, the second probe 22 which extends through the corresponding opening 41 of the adapter plate 40 dips into the cavity to be cleaned, whereas the return line 32 is guided into the storage vessel 30.

The first pump 25 is then first of all switched on, with the result that alkaline cleaning liquid is injected into the inlet channel 11. As soon as a sufficient quantity of alkaline cleaning liquid is situated in the inlet channel after a predefined time, the second pump 35 is switched on in order to extract liquid and contaminants by suction. Here, the delivery rate of the two pumps should be substantially identical, in order to maintain a constant liquid level in the inlet channel 10 during the cleaning.

The cleaning of the inlet channel 10 and of the inlet valve 15 subsequently takes place in the same way as described above, only with the difference that the cleaning liquid which is filtered by the filter 27 is guided back into the storage vessel 30, before it is injected into the inlet channel again by the pressure pump 25 via the heater 29.

Should it occur that the delivery rate of the first pump, that is to say of the pressure pump, is actually greater than the extraction rate of the second pump, excess liquid can be collected reliably via the overflow line 42 into a corresponding collecting vessel.

The use of two pumps, that is to say of an extraction pump and a pressure pump, for feeding cleaning liquid to the cavity to be cleaned has the advantage that the injection and extraction by suction of alkaline cleaning liquid can be controlled independently of one another. Furthermore, not only can the cleaning effectiveness be increased in this way, since the cleaning liquid is not consumed so quickly, but also the operational safety in the workshop can also be improved substantially, although an open liquid circuit is used, since the probes can both be introduced in a sealed manner with the aid of the adapter plate 40 into the cavity to be cleaned, and the intake and return lines are inserted in a sealed manner into the storage vessel.

1. A method for cleaning coked cavities, in particular inlet channels (10) and valves (15) of an internal combustion engine (12), having the following steps:
introduction of an alkaline liquid into a cavity to be cleaned,
heating of the alkaline liquid, and
extraction by suction of the alkaline liquid with the dirt particles contained therein from the cavity,

2. The method as claimed in claim 1, characterized in that a base in solid form and a solvent are mixed with one another and are introduced into the cavity to be cleaned, with the result that the alkaline liquid which, in particular, has a pH value of more than 12 is formed in the cavity to be cleaned by dissolving of the base in the solvent with the development of heat.

3. The method as claimed in claim 1, characterized in that
the alkaline liquid which, in particular, has a pH value of more than 12 is heated before being introduced, and
the heated alkaline liquid is injected into the cavity.

4. The method as claimed in claim 3, characterized in that the alkaline liquid with the dirt particles contained therein is extracted by suction from the cavity, while alkaline liquid continues to be injected into the cavity, with the result that the cavity is flushed continuously with alkaline liquid.

5. The method as claimed in claim 3 or 4, characterized in that
the alkaline liquid with the dirt particles contained therein is extracted by suction from the cavity and is subsequently filtered, in order to remove the dirt particles contained therein, and
the filtered alkaline liquid is heated and is subsequently injected into the cavity again.

6. The method as claimed in claim 3, 4 or 5, characterized in that the alkaline liquid is sprayed under pressure against the walls and the bottom of the cavity.

7. The method as claimed in one of the preceding claims, characterized in that, after the extraction by suction of the alkaline liquid has ended, the cavity is dried by means of compressed air.

8. A device for cleaning coked cavities, in particular inlet channels (10) and valves (15) of an internal combustion engine (12), having
a first probe (21) which is provided at its front end with one or more nozzles (23, 23′) for injecting an alkaline liquid into a cavity to be cleaned and which is connected with its other end to the pressure side (24) of a pump (25), the suction side (26) of which can be fed heated alkaline liquid, and
a second probe (22) for extracting the alkaline liquid with the dirt particles contained therein by suction from the cavity.

9. The device as claimed in claim 8, characterized in that the second probe (22) is connected to the suction side (26) of the pump (25) via a filter (27) for removing dirt particles from the alkaline liquid.

10. The device as claimed in claim 9, characterized in that the outlet side of the filter (27) is connected via a connecting line (28) to the suction side (26) of the pump (25), the connecting line (28) or the pressure side of the pump (25) being assigned a heater (29) for heating a liquid which flows through.

11. The device as claimed in one of claims 8 to 10, characterized in that the first probe (21) is a thin tube which is closed at its front end and in the circumferential wall of which a plurality of radially directed nozzles (23) are provided.

12. The device as claimed in claim 11, characterized in that the nozzles (23) are arranged on a line which is parallel to the axis of the tube or on one or more helixes (SL) or on one or more circumferential circles, or in that at least one nozzle (23′) is provided in the region of the closed front end, through which at least one nozzle (23′) the alkaline liquid can be sprayed substantially in the axial direction (A) of the tube of the probe (21).

13. The device as claimed in one of claims 9 to 11, characterized in that the first probe (21) has at least two nozzles (23, 23′) for injecting the alkaline liquid into the cavity to be cleaned, which nozzles (23, 23′) spray the alkaline liquid in different directions.

14. The device as claimed in claim 8, characterized in that the second probe (22) is connected via a filter (27) for removing dirt particles from the alkaline liquid to the suction side (36) of a second pump (35) which serves as a suction pump and the outlet or pressure side of which is connected to a storage vessel (30).

15. The device as claimed in claim 14, characterized in that the suction side (26) of a pump (25) which serves as a pressure pump is connected via an intake line (28) to the storage vessel (30), the pressure side of the pump (25) or the intake line (28) being assigned a heater (29) for heating a liquid which flows through.

16. The device as claimed in one of the preceding claims, characterized in that, furthermore, a covering device (40) is provided for covering the opening of the cavity to be cleaned, which covering device (40) has two leadthroughs (41) for the first and second probes (21, 22) and is provided with an overflow line (42) which can be connected to a collecting vessel.
